(19) United States
(12) Patent Application Publication
(10) Pub. No.: US 2013/0075123 A1
(43) Pub. Date: Mar. 28, 2013

(54) FORWARD/REVERSE ROTATION CONTROL DEVICE OF PNEUMATIC TOOL

(71) Applicants: YUNG-YUNG SUN, TAICHUNG CITY (TW); CHUAN-CHING CHENG, TAICHUNG CITY (TW)

(72) Inventors: YUNG-YUNG SUN, TAICHUNG CITY (TW); CHUAN-CHING CHENG, TAICHUNG CITY (TW)

(73) Assignee: STORM PNEUMATIC TOOL CO., LTD., TAICHUNG CITY (TW)

(21) Appl. No.: 13/239,591

(22) Filed: Sep. 22, 2011

(51) Int. Cl. B25F 5/00

(52) U.S. Cl. 173/221

(57) ABSTRACT

A forward/reverse rotation device of a pneumatic tool comprising a clutch switch that can be pressed towards the inside of a switching valve to separate a steering switch from its connection with a positioning element, and the steering switch is turned from a side of a handle of the pneumatic tool to the other opposite side, and the clutch switch is bounced to resume its original position by the support of an elastic element, so as to connect the steering switch with the positioning element again. A sleeve portion of the steering switch is coaxially and pivotally installed at a center rod of the clutch switch, and the steering switch is turned between both sides of the handle and maintained to be pivotally turned on the center rod.

### BACKGROUND OF THE INVENTION

1. Field of the Invention

The present invention relates to an improved switch structure of a pneumatic tool, and more particularly to an improved forward/reverse rotation control device of a pneumatic tool.

2. Brief Description of the Related Art

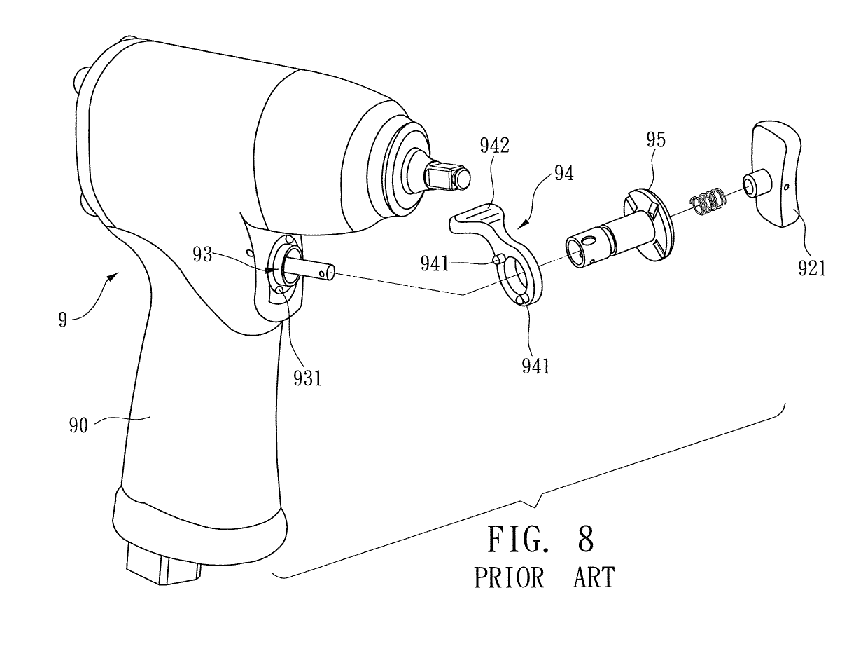

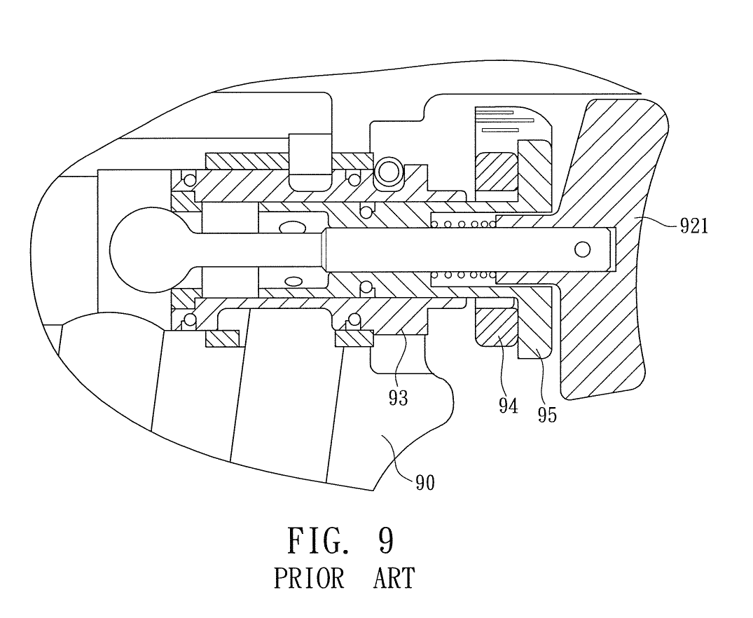

With reference to FIGS. 8 and 9 for a pneumatic tool 9, a turning portion 942 of the pneumatic tool 9 can be adjusted from a side to the other side of a handle 90 to fit the left-handed or right-handed using habit of a user. The user can pull a clutch switch 95 towards a press button 921 to retract two protrusions 941 of a steering switch 94 from two notches 931 of a switching valve 93 in order to turn a turning portion 942 of the steering switch 94 to the other side. After the clutch switch 95 is released, the protrusion 941 and the notch 931 are connected with each other again.

However, when the user pulls the clutch switch 95 towards the press button 921, the user needs to pull the clutch switch 95 by one hand and align the two protrusions 941 of the steering switch 94 with the two notches 931 of the switching valve 93 by the other hand to release the clutch switch 95 and compress and position the steering switch 94.

### SUMMARY OF THE INVENTION

Therefore, it is a primary objective of the present invention to overcome the aforementioned problems by providing an improved forward/reverse rotation device of a pneumatic tool, such that when a turning portion of the steering switch is adjusted from a side of a handle to the other opposite side, a quick and convenient adjustment can be made effectively.

To achieve the foregoing objective, the present invention provides a forward/reverse control device of a pneumatic tool, wherein the pneumatic tool comprises a trigger module including a press button and an air inlet pressure rod handle in a switch chamber, and a steering switch unit including a switching valve, a clutch switch and a steering switch, and the trigger module controls a high-pressure gas to enter from an air inlet passage to drive and rotate an air motor, and the steering switch on any one of both sides of the handle can drive a deflection of the switching valve to control a forward or reverse rotation of the air motor, characterized in that the steering switch unit further comprises an elastic element and a positioning element, wherein:

The switching valve includes a first penetrating hole axially penetrating through the switching valve and an air outlet radially interconnected to the first penetrating hole, and the air outlet is selectively interconnected to an air passage for driving the air motor to rotate in a forward direction or in a reverse direction according to the deflection of the switching valve, and the switching valve has a combining end formed outwardly at an end of the switching valve, and the switching valve has groove chamber formed at the combining end and axially interconnected to the first penetrating hole.

The clutch switch includes a press portion, a center rod extended axially from the press portion, a second penetrating hole penetrating through the center rod, and the center rod being formed by coupling a large-diameter section and a small-diameter section, and a shoulder portion disposed at a connecting position of the large-diameter section and the small-diameter section, and the small-diameter section having at least one inwardly concave circular groove.

The steering switch includes a sleeve portion and a turning portion extended laterally from the sleeve portion, and a third penetrating hole penetrating through the sleeve portion and pivotally sheathed on the large-diameter section, and the sleeve portion being maintained at a pivotal connection with the large-diameter section by a third penetrating hole, and the sleeve portion has a thickness smaller than the length of the large-diameter section and can be axially displaced on the large-diameter section.

The elastic element is installed between the press portion and the sleeve portion, and the press portion and the sleeve portion are supported axially by the elastic element in opposite directions, wherein the sleeve portion is supported and abutted against a distal surface of the combining end, and when the press portion is pressed towards the sleeve portion, the press portion is bounced to resume its original position by the elastic element.

The positioning element includes a fourth penetrating hole sheathed on the small-diameter section, and the distal surface of the positioning element an end is blocked by the shoulder portion, and the distal surface at the other end is latched into a C-shaped buckle in the circular groove, and the sleeve portion is limited by the positioning element and the press portion at the large-diameter section. The positioning element together with the small-diameter section of the center rod are placed into and limited by the groove chamber, and the pressure rod of the air inlet is passed from the second penetrating hole of the center rod and out of the press portion to couple with the press button, and the press portion is supported by the elastic element to link the positioning element to approach the sleeve portion, and the positioning element has a thickness smaller than the depth of the groove chamber and is then axially moved towards the interior of the groove chamber and in a direction away from the sleeve portion. When the positioning element is rotated radially, the switching valve is driven to deflect synchronously.

The sleeve portion has a first junction disposed around the periphery of the third penetrating hole, and the positioning element has a second junction, and one of the first and second junctions is concave and the other one is convex to facilitate a connection, and at least one of the junctions is convex, and at least two of the junctions are concave and disposed on both opposite sides respectively, and the at least one convex junction can be adjusted to a connecting position of the concave junction on any side, so that the concave and convex junctions can be engaged and connected. The positioning element is situated proximate to the sleeve portion, so that the concave and convex junctions can be engaged to turn the positioning element together with the turning portion to drive a deflection of the switching valve, and the positioning element is situated away from the sleeve portion, so that the concave and convex junctions can be separated from one another, and the turning portion can be selectively situated on any one of both sides of the handle.

### BRIEF DESCRIPTION OF THE INVENTION

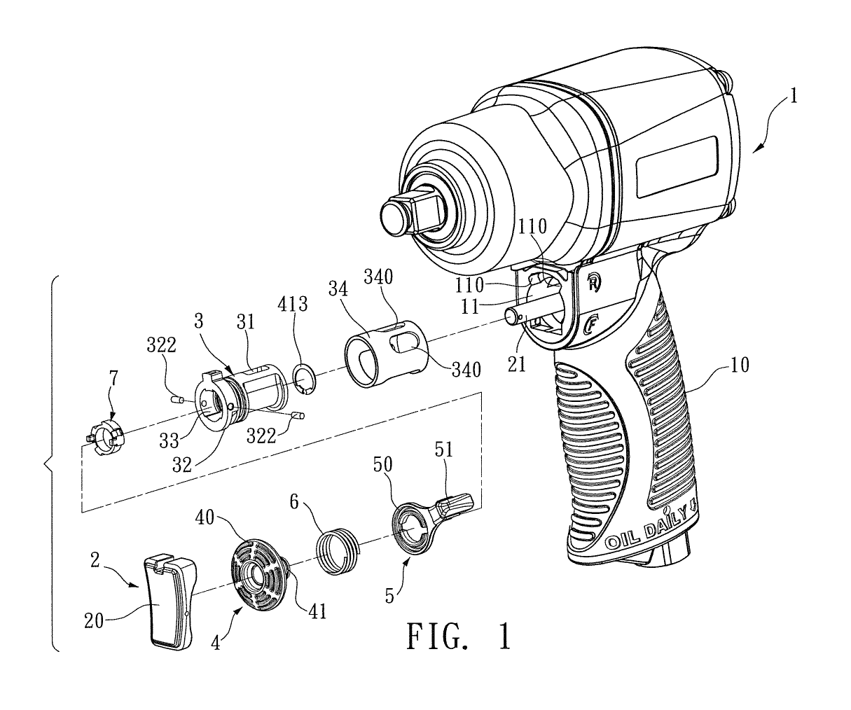

FIG. 1 is an exploded view of the present invention;

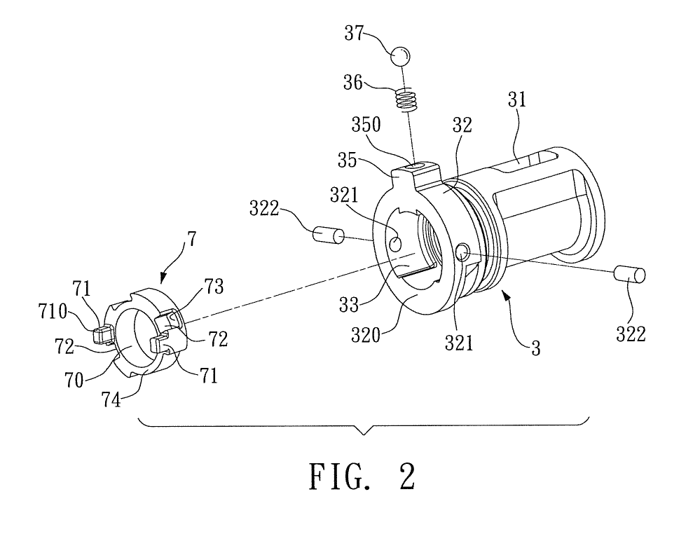

FIG. 2 is a perspective view of a switching valve and a positioning element of the present invention;

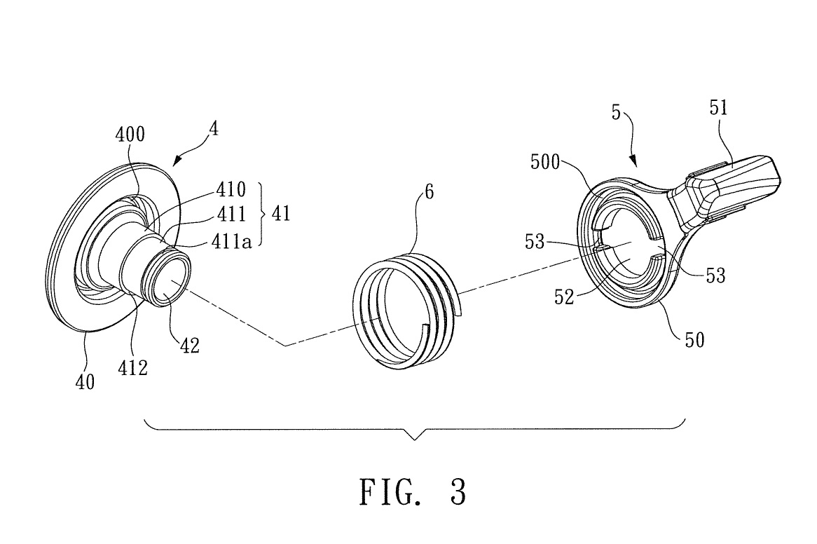

FIG. 3 is a perspective view of a clutch switch, a steering switch and an elastic element of the present invention;

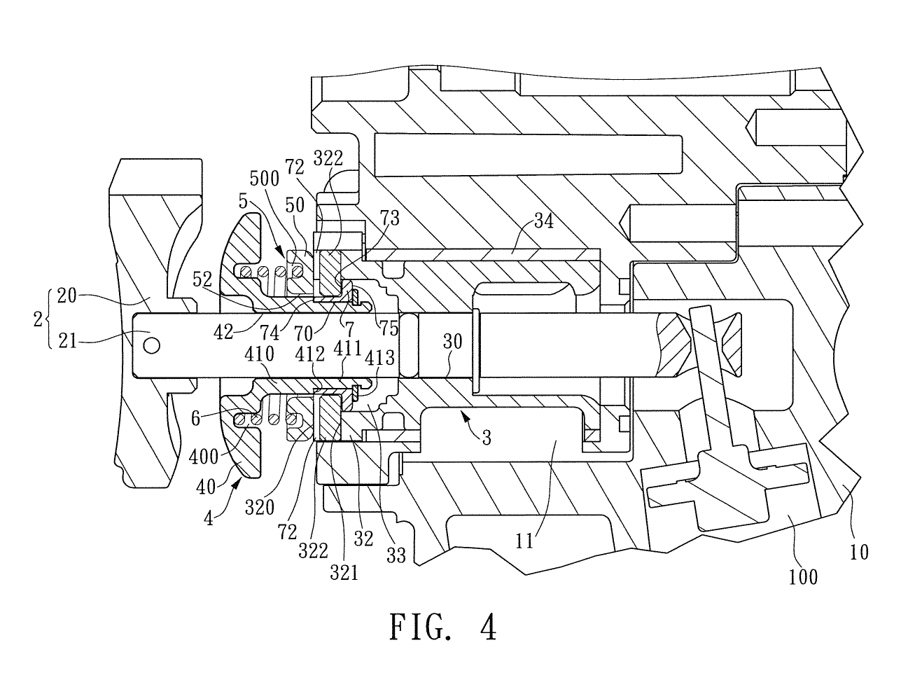

FIG. 4 is a cross-sectional view of a bolt blocked and positioned into a pocket of a positioning element in accordance with the present invention;

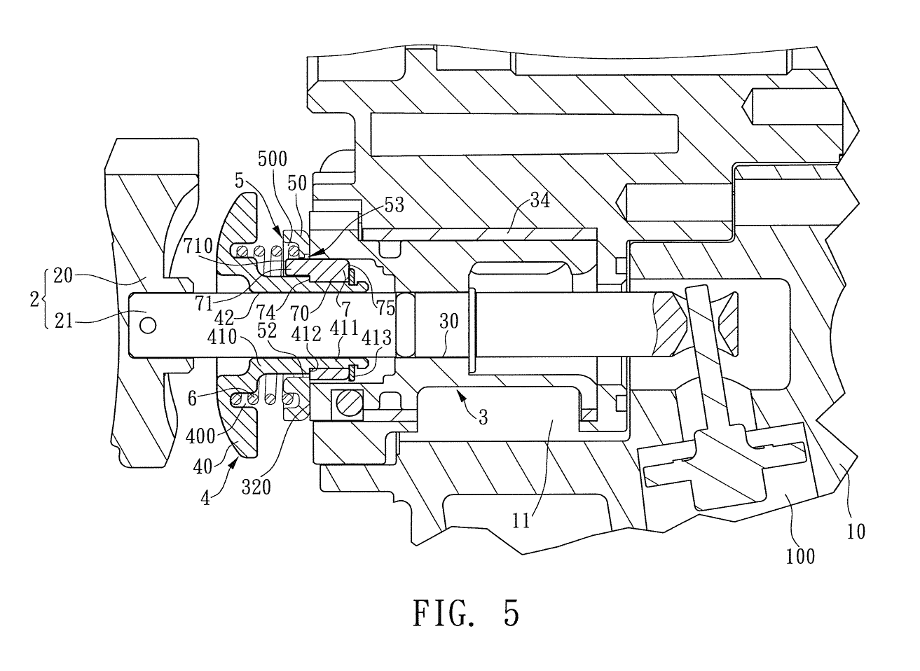

FIG. 5 is a cross-sectional view of a protrusion of a positioning element and a slot of a sleeve portion being coupled with each other in accordance with the present invention;

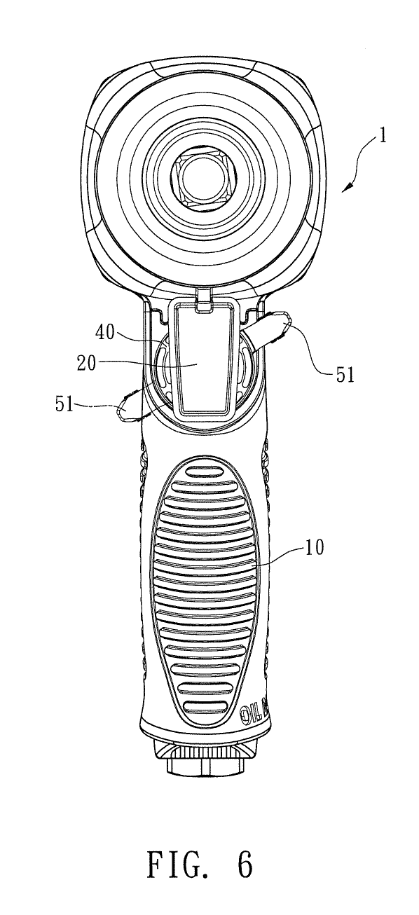

FIG. 6 is a schematic view of flipping a flip portion from a right side to a left side in accordance with the present invention;

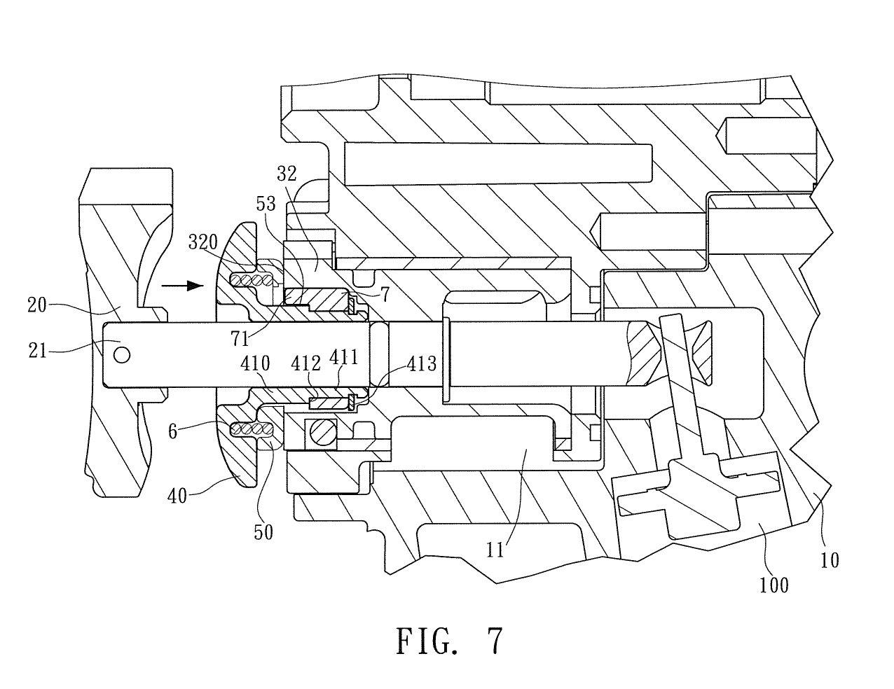

FIG. 7 is a schematic view of a press portion being press to release a protrusion of a positioning element from a slot of a sleeve portion in accordance with the present invention;

FIG. 8 is an exploded view of a conventional forward/reverse rotation device of a pneumatic tool; and

FIG. 9 is a cross-sectional view of a conventional forward/reverse rotation device of a pneumatic tool.

### DETAILED DESCRIPTION OF THE PREFERRED EMBODIMENTS

With reference to FIGS. 1 to 7 for a preferred embodiment of the present invention, a pneumatic tool 1 of this preferred embodiment as shown in FIG. 1 comprises a handle 10 having a switch chamber 11 formed therein, and a trigger module 2 and a steering switch unit installed in the switch chamber 11, wherein the trigger module 2 controls a high-pressure gas to enter from an air inlet passage 100 of the handle 10, and the pneumatic tool 1 includes an air passage for rotating an air motor forward and an air passage for rotating the air motor reverse (and the air motor and two air passages are not shown in the figures). By using the steering switch unit to control the high-pressure gas to pass through any air passage, the forward and reverse rotation of the air motor can be controlled (wherein F indicates a forward rotation, and R indicates a reverse rotation). The trigger module 2 includes a press button 20 and an air inlet pressure rod 21, and the steering switch unit includes a switching valve 3, a clutch switch 4, a steering switch 5, an elastic element 6 and a positioning element 7.

In FIGS. 2 and 4, the switching valve 3 of this preferred embodiment has a first penetrating hole 30 axially penetrating through the switching valve 3, an air outlet 31 formed on the switching valve 3 and radially interconnected to the first penetrating hole 30, and the air outlet 31 is selectively interconnected to the two air passages according to the rotation of the switching valve 3. The switching valve has a combining end 32, and the switching valve 3 has a groove chamber 33 formed in the combining end 32 and axially interconnected to the first penetrating hole 30. In this preferred embodiment, an outer sleeve 34 is contained in the switch chamber 11 of the handle 10, and the outer sleeve 34 has two through holes 340 interconnected to the two air passages respectively, and the switching valve 3 is sheathed into the outer sleeve 34, and the combining end 32 is exposed from an end of the outer sleeve 34. The air outlet 31 of the switching valve 3 can be selectively interconnected to the two through holes 340 according to the rotation direction. The combining end 32 has a bump 35 radially protruded from the combining end 32, and the bump 35 includes a groove hole 350 formed therein and a spring 36 and a bead 37 are installed in the groove hole 350. The switch chamber 11 has two positioning grooves 110 formed on an internal wall of the switch chamber 11 as shown in FIG. 1, such that when the switching valve 3 is rotated to a forward or reverse position, the bead 37 is used for the supporting and positioning purpose in any positioning groove 110.

In FIGS. 3 and 4, the clutch switch 4 has a press portion 40, and the press portion 40 includes a center rod 41 axially installed on the press portion 40 and penetrating through a second penetrating hole 42, and center rod 41 is formed by coupling a large-diameter section 410 and a small-diameter section 411.

In FIGS. 3 and 4, the steering switch 5 has a sleeve portion 50 and a turning portion 51, and a third penetrating hole 52 penetrates through the sleeve portion 50 and can be pivotally sheathed on the large-diameter section 410, and the sleeve portion 50 has a thickness smaller than the length of the large-diameter section 410, so that the sleeve portion 50 can be displaced axially on the large-diameter section 410. The sleeve portion 50 includes first junctions disposed at the periphery of the third penetrating hole 52, and each first junction of this preferred embodiment is a concavely formed slot 53.

In FIGS. 3 and 4, the elastic element 6 of this preferred embodiment is a compression spring installed between the press portion 40 and the sleeve portion 50, and the press portion 40 and the sleeve portion 50 are supported in different directions by the elastic element 6, wherein the sleeve portion 50 is supported and abutted at a distal surface 320 of the combining end 32. When the press portion 40 is pressed towards the sleeve portion 50, the elastic element 6 is compressed. When the elastic element 6 is bounced in an opposite direction, the press portion 40 resumes its original position. In this preferred embodiment, the press portion 40 includes a first recession 400 formed around the external periphery of the center rod 41, and the sleeve portion 50 has a second recession 500 disposed corresponding to the first recession 400, and both ends of the elastic element 6 are placed into the first recession 400 and the second recession 500 respectively.

In FIGS. 2 and 4, the positioning element 7 is situated in the groove chamber 33, and the air inlet pressure rod 21 is passed out from the second penetrating hole 42 of the center rod 41, and coupled to the press button 20 outside the press portion 40. The positioning element has a fourth penetrating hole 70 sheathed on the small-diameter section 411, and the center rod 41 has a shoulder portion 412 disposed at a connecting position of the large-diameter section 410 and the small-diameter section 411, and a distal surface 74 at an end of the positioning element 7 is blocked by the shoulder portion 412, and the small-diameter section 411 on a distal surface 75 at another end has an inwardly concave circular groove 411a, and a C-shaped buckle 413 is installed inside the circular groove 411a for stopping the positioning element 7, so that the C-shaped buckle 413 and the shoulder portion 412 limit the positioning element 7 at the small-diameter section 411, and the sleeve portion 50 is limited at the large-diameter section 410 by the positioning element 7 and the press portion 40.

In FIG. 4, when the press portion 40 is propped by the elastic element 6 to move towards the press button 20, the positioning element 7 is linked to approach the sleeve portion 50, and the positioning element 7 has a thickness smaller than the depth of the groove chamber 33, so that when the press portion 40 is pressed to axially move the positioning element 7 towards the interior of the groove chamber 33, the positioning element 7 and the sleeve portion 33 are disposed away from each other. In FIGS. 2 and 5, the positioning element 7 has two second junctions, each positioning portion of this preferred embodiment is a protrusion 71, and the two protrusions 71 are disposed on both opposite sides of the fourth penetrating hole 70 respectively (only one is shown in the figure), and the two protrusions 71 have a chamfer 710 formed at the top of each protrusion 71 to guide the protrusion 71 to enter into the slot 53, and the two protrusions 71 are disposed opposite to the two slots 53 respectively. When the positioning element 7 is propped by the elastic element 6 to approach the sleeve portion 50, the two protrusions 71 of the positioning element 7 are placed into the two slots 53 of the sleeve portion 50 respectively and engaged. Now, if the positioning element 7 is turned together with the turning portion 51, the switching valve 3 can be driven to rotate. When the press portion 40 is pressed to extend the center rod 41 into the groove chamber 33, the positioning element 7 is axially moved together with the center rod and away from the sleeve portion 50, so that the two protrusions 71 of the positioning element 7 can be separated from the two slots 53 of the sleeve portion. Now, the sleeve portion 50 can be rotated pivotally and freely on the large-diameter section 410 with respect to the center rod 41, and the turning portion 51 can be selectively situated on any one of both sides of the handle.

In FIGS. 1 and 2, the positioning element 7 of this preferred embodiment has an external contour matched with an internal contour of the groove chamber 33 and contained in the groove chamber 33 and cannot be radially and pivotally rotated, so that when the positioning element 7 rotates, the switching valve 3 is driven to rotate. In FIG. 2, the switching valve 3 of this preferred embodiment is penetrated through the combining end 32 and the side hole 321 interconnected to the groove chamber 33, and each of the positioning elements 7 at opposite positions of the two side holes 321 has a pocket 72, and a retaining wall 73 formed on a sidewall of the pocket 72, and a bolt 322 is passed into the side hole 321 and extended into the pocket 72 of the positioning element 7. When the press portion 40 is outwardly propped by the elastic element 6, the bolt 322 is blocked at the retaining wall 73 of the positioning element 7 to limit the positioning element 7 in the groove chamber 33.

In FIG. 6, the turning portion 51 of the steering switch 5 is situated on the right side of the figure. Now, the turning portion 51 can be turned up and down on a side to switch the forward or reverse rotation of the air motor. If it is necessary to adjust the turning portion 51 from the right side to the left side as shown in the figure, a user can push the press portion 40 of the clutch switch 4 to move in a direction towards the switching valve 3 as shown in FIG. 7, and the fixing element 7 can be moved axially with the center rod 41 away from the sleeve portion 50. The two protrusions 71 of positioning element 7 and the two slots 53 of the sleeve portion 50 are separated from one another, so that the sleeve portion 50 can be pivotally rotated on the center rod 41, and the turning portion 51 can be adjusted from the right side to the left side as shown in FIG. 6. Since the third penetrating hole 52 in sleeve portion 50 is axially installed with the center rod 41, and the press portion 40 is propped outwardly and continuously by the elastic element 6, therefore when the turning portion 51 starts turning, the press portion 40 can be released, and the turning portion 51 keeps rotating. When the two protrusions 71 are opposite to the slots 53, the chamfer 710 at the top of the two protrusions 71 is provided for guiding, and the two protrusions 71 can be displaced axially with the positioning element 7 and automatically inserted into the two slots 53. Now, the press portion 40 is bounced by the elastic element 6 to resume its original position. The positioning element 7 also resumes its position proximate to the sleeve portion 50, and the turning portion 51 can be turned up and down on the left side of the figure to drive the positioning element 7 to rotate, so that the switching valve 3 can be rotated to switch the rotating direction of the air motor.

In summation of the description above, the present invention has the following advantages. With the elastic element 6 normally props the sleeve portion 50 to abut at the distal surface 320 of the combining end 32, when the press portion 40 is pressed towards the sleeve portion 50, the elastic element 6 is compressed to further press the sleeve portion 50 onto the distal surface 32, so that the sleeve portion at the large-diameter section 410 will not have an axial displacement. Now, the sleeve portion 50 is coaxially installed at the large-diameter section 410, and when the sleeve portion 50 is pivotally rotated on the center rod 41, the coaxial position can be maintained. Therefore, users simply need to turn the turning portion 51 towards the other side to switch the turning portion 51 to the other side, so that the first junction and the second junction are situated opposite to each other. Since the press portion 40 is pushed by the elastic element 6 to move towards the press button 20, the first junction and the second junction can be engaged automatically, and the turning portion 51 of the steering switch 5 can be used for adjusting and changing a direction conveniently and quickly.

What is claimed is:

1. A forward/reverse rotation device of a pneumatic tool, comprising: a trigger module including a press button and an air inlet pressure rod, installed in a switch chamber of a handle of the pneumatic tool, and a steering switch unit including a switching valve, a clutch switch and a steering switch, and the trigger module controlling a high-pressure gas to enter from an air inlet passage to drive and rotate an air motor, and the steering switch driving a deflection of a switching valve on any one of both sides of the handle to control a forward or reverse rotation of the air motor, characterized in that the steering switch unit further comprises an elastic element and a positioning element, wherein the switching valve has a first penetrating hole axially penetrating the switching valve and an air outlet radially interconnected to the first penetrating hole, and the air outlet is selectively interconnected to an air passage for driving the air motor to rotate in a forward direction or in a reverse direction according to the deflection of the switching valve, and the switching valve has a combining end formed outwardly at an end of the switching valve, and the switching valve has groove chamber formed at the combining end and axially interconnected to the first penetrating hole;
the clutch switch includes a press portion, a center rod extended axially from the press portion, a second penetrating hole penetrating through the center rod, and the center rod being formed by coupling a large-diameter section and a small-diameter section, and a shoulder portion disposed at a connecting position of the large-diameter section and the small-diameter section, and the small-diameter section having at least one inwardly concave circular groove;
the steering switch steering switch includes a sleeve portion and a turning portion extended laterally from the sleeve portion, and a third penetrating hole penetrating through the sleeve portion and pivotally sheathed on the large-diameter section, and the sleeve portion being maintained at a pivotal connection with the large-diameter section by a third penetrating hole, and the sleeve portion has a thickness smaller than the length of the large-diameter section and can be axially displaced on the large-diameter section;
the elastic element is installed between the press portion and the sleeve portion, and the press portion and the sleeve portion are supported axially by the elastic element in opposite directions, wherein the sleeve portion is supported and abutted against a distal surface of the combining end, and when the press portion is pressed towards the sleeve portion, the press portion is bounced to resume its original position by the elastic element;
the positioning element includes a fourth penetrating hole sheathed on the small-diameter section, and the distal surface of the positioning element an end is blocked by the shoulder portion, and the distal surface at the other end is latched into a C-shaped buckle in the circular groove, and the sleeve portion is limited by the positioning element and the press portion at the large-diameter section; the positioning element positioning element together with the small-diameter section of the center rod are placed into and limited by the groove chamber, and the pressure rod of the air inlet is passed from the second penetrating hole of the center rod and out of the press portion to couple with the press button, and the press portion is supported by the elastic element to link the positioning element to approach the sleeve portion, and the positioning element has a thickness smaller than the depth of the groove chamber and is then axially moved towards the interior of the groove chamber and in a direction away from the sleeve portion, and when the positioning element is rotated radially, the switching valve is driven to deflect synchronously; and
the sleeve portion has a first junction disposed around the periphery of the third penetrating hole, and the positioning element has a second junction, and one of the first and second junctions is concave and the other one is convex to facilitate a connection, and at least one of the junctions is convex, and at least two of the junctions are concave and disposed on both opposite sides respectively, and the at least one convex junction can be adjusted to a connecting position of the concave junction on any side, so that the concave and convex junctions can be engaged and connected, and the positioning element is situated proximate to the sleeve portion, so that the concave and convex junctions can be engaged to turn the positioning element together with the turning portion to drive a deflection of the switching valve, and the positioning element is situated away from the sleeve portion, so that the concave and convex junctions can be separated from one another, and the turning portion can be selectively situated on any one of both sides of the handle.

2. The forward/reverse rotation device of a pneumatic tool as recited in claim 1, wherein the first junction is a concave slot, and the second junction is a protrusion.

3. The forward/reverse rotation device of a pneumatic tool as recited in claim 2, wherein the protrusion includes a chamfer formed at the top of the protrusion.

4. The forward/reverse rotation device of a pneumatic tool as recited in claim 1, wherein the press portion includes a first recession formed around the external periphery of the center rod, and the sleeve portion has a second recession, and the second recession and the first recession are installed opposite to each other, and both ends of the elastic element are disposed into the first recession and the second recession respectively.

5. The forward/reverse rotation device of a pneumatic tool as recited in claim 1, wherein the combining end has at least one side of the periphery passed into a side hole and interconnected to the groove chamber, and the positioning element has a pocket formed at an opposite position of the side hole, and a retaining wall formed on a sidewall of the pocket, and a bolt is passed into the side hole and extended into the pocket of the positioning element, and when the press portion is propped outwardly by the elastic element, the bolt is provided for blocking the retaining wall of the positioning element to limit the positioning element in the groove chamber.

6. The forward/reverse rotation device of a pneumatic tool as recited in claim 1, wherein the combining end has a bump radially protruded from the periphery of the combining end, and the bump includes a longitudinal groove hole, a compression spring installed in the groove hole, a bead installed onto the compression spring, and two positioning grooves formed on an internal wall of the switch chamber, and the bead is provided for supporting and positioning in any groove when the switching valve is deflected to a forward or reverse position.

7. The forward/reverse rotation device of a pneumatic tool as recited in claim 1, further comprising an outer sleeve contained in the switch chamber of the handle, and the outer sleeve having two through holes interconnected to the two air passages respectively, and the switching valve being pivotally sheathed into the outer sleeve, and the combining end being exposed from an end of the outer sleeve, and the air outlet of the switching valve being interconnected to the two through holes according to a deflection direction.

8. The forward/reverse rotation device of a pneumatic tool as recited in claim 1, wherein the groove chamber has an internal contour substantially in a butterfly shape in the combining end, and an external contour of the positioning element is also substantially in a butterfly shape, and the external contour of the positioning element is matched with the internal contour of the groove chamber and contained into the groove chamber.
